(19) United States
(12) Patent Application Publication
(10) Pub. No.: US 2026/0134212 A1
(43) Pub. Date: May 14, 2026

(54) LLM-REFLECTION BASED ADAPTIVE PROMPT CORRECTION IN MULTISTAGE WORKFLOWS

(71) Applicant: International Business Machines Corporation, Armonk, NY (US)

(72) Inventors: Zhong Fang Yuan, Xi'an (CN); Tong Liu, Xi'an (CN); Chen Gao, Xi'an (CN); Allison Chen, New Taipei City (TW)

(73) Assignee: International Business Machines Corporation, Armonk, NY (US)

(21) Appl. No.: 18/944,149

(22) Filed: Nov. 12, 2024

(51) Int. Cl. G06F 16/332

(52) U.S. Cl. CPC G06F 40/279; G06F 16/24522; G06F 16/33295

(57) ABSTRACT

An error in an output of a model is identified while processing a prompt through the model. The error is converted into a score. The model is triggered to convert the prompt into an argument structure. Using the score and the argument, the model is caused to identify a part of the argument that should be replaced. a replacement part corresponding to the part is generated from the model such that replacing the part with the replacement part will cause a revised prompt to result in a lower revised score. Using the model, the part in the argument is replaced with the replacement part to form a revised argument, and a revised prompt is generated using the model and the revised argument.

### BACKGROUND

The present invention relates generally to the field of artificial intelligence using generative models such as Large Language Models, automatic machine learning, prompt engineering, and data science. More particularly, the present invention relates to a method, system, and computer program for LLM-reflection based adaptive prompt correction in multistage workflows.

Artificial intelligence (AI) technology has evolved significantly over the past few years. Modern AI systems are achieving human-level performance on cognitive tasks like converting speech to text, recognizing objects and images, and translating between different languages. This evolution holds promise for new and improved applications in many industries.

A Large Language Model (LLM, plural LLMs, model, plural models) is a type of software designed to understand and generate human-like text. LLMs are trained on massive amounts of data from books, articles, websites, and other written sources. At their core, LLMs use a neural network in a transformer architecture that has layers of interconnected nodes that process and interpret text data. An Artificial Neural Network (ANN) is a computing system made up of a number of simple, highly interconnected processing elements, which process information by their dynamic state response to external inputs. ANNs are processing devices (algorithms and/or hardware) that are loosely modeled after the neuronal structure of the mammalian cerebral cortex but on smaller scales. A large ANN implementation of an LLM might have tens of millions of interconnected nodes. By comparison, a mammalian brain has billions of neurons with a corresponding increase in the magnitude of their overall interaction and emergent behavior.

A multistage workflow refers to a process that involves breaking down a complex task into multiple stages or steps, with each stage focusing on a different aspect of the problem. Each stage can involve different processing techniques, models, or prompts to achieve a more accurate or refined result than a single-step approach.

Multistage workflows are particularly useful in tasks that require multiple layers of reasoning, understanding, or transformation. In LLMs, such workflows help improve the quality of the output, making them more reliable for tasks like question answering, document summarization, code generation, and many other tasks.

A multistage workflow involves running several steps sequentially, where the output of one step becomes the input for the next, with or without another prompt. A multistage workflow can include intermediate reasoning or extraction of useful information before generating the final result.

LLM Reflection refers to the process in which a large language model engages in a self-evaluative or self-correcting process. This reflective capability allows the model to analyze its own generated responses, reason through possible errors or inconsistencies, and improve its output in a systematic way.

Reflection in LLMs can be seen as a higher-order reasoning process that enables the model to improve the quality of its responses, reduce errors, and enhance alignment with user intent. In essence, the reflection process allows the model to “think” more deeply about what it is generating, similar to how humans reflect on their thoughts or actions. Using reflection, the LLM can generate a response to a prompt, then reanalyze or reevaluate that response by examining it for clarity, correctness, or coherence. Based on this reflection, the model may revise the initial output. For example, if an LLM generates an incorrect answer to a factual question, the model can reflect on its reasoning, compare the response to known facts, and provide a corrected answer.

The illustrative embodiments recognize that presently prompt refinement using LLM reflection is limited in the manner the refinement is conducted and limited in scope of the refinement. For example, presently, LLM reflection can involve iterative cycles of prompt refinement, where the model reinterprets the user's prompt or intent after an initial response. The model can then generate a more aligned response based on deeper reflection about what the user is asking.

The current LLM-based workflow often uses a multistep prompt to form a workflow. The basic process for multistep or multistage workflow allows not having to write all the prompts for all the stages at once, but to complete the prompt input step by step, and then combine the results with the next prompt as a new input to the LLM until the final result is obtained. However, the illustrative embodiments recognize that this method greatly increases the complexity of the prompt project. The illustrative embodiments recognize that when the next prompt in the multistage workflow is generated or modified the prompt, the impact of the generation or modification on the preceding and following prompts has to be considered also. The illustrative embodiments recognize that this whole process is delicate and a single move affects the whole body. The illustrative embodiments recognize that a small modification in prompt-1 will lead to different results, and the different results will have a greater impact on the generation of the next result, and so on, and in the end, the LLM produces a completely different answer. This phenomenon is also called the “butterfly effect” of the prompt chain.

The illustrative embodiments described herein provide a novel method of prompt adjustment using LLM reflection. The novel method described herein is self-executing by the LLM and adaptive to some preliminary prompts which start the multistage workflow and trigger automatic adjustment of the prompts of different steps at the same time as adjusting the neural network parameter weights until the optimal result is achieved.

### SUMMARY

The illustrative embodiments provide for LLM-reflection based adaptive prompt correction in multistage workflows. An embodiment includes identifying, responsive to processing a prompt through a model, an error in an output of the model. The embodiment further includes converting the error into a score. The embodiment further includes triggering the model to convert the prompt into an argument structure (argument). The embodiment further includes causing, using the score and the argument, the model to identify a part of the argument to be replaced. The embodiment further includes generating from the model a replacement part corresponding to the part such that replacing the part with the replacement part will cause a revised prompt to result in a lower revised score. The embodiment further includes replacing, using the model to form a revised argument, the part in the argument with the replacement part. The embodiment further includes generating, using the model, from the revised argument the revised prompt.

Other embodiments of this aspect include corresponding computer systems, apparatus, and computer programs recorded on one or more computer storage devices, each configured to perform the actions of the embodiment.

An embodiment includes a computer-usable program product. The computer-usable program product includes a computer-readable storage medium and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 depicts a block diagram of a configuration for LLM-reflection based adaptive prompt correction in multistage workflows in accordance with an illustrative embodiment;

FIG. 3 depicts a configuration and operation of error detection and quantification in accordance with an illustrative embodiment;

FIG. 4A depicts one portion of a five-paragraph argument form of a prompt to be tokenized for argument adjustment in accordance with an illustrative embodiment;

FIG. 4B depicts another portion of the five-paragraph argument form of a prompt to be tokenized for argument adjustment in accordance with an illustrative embodiment;

FIG. 4C depicts an example portion of the tokenized five-paragraph argument form of the prompt in accordance with an illustrative embodiment;

FIG. 5 depicts a process of argument adjustment in accordance with an illustrative embodiment; and

FIG. 6 depicts a flowchart of an example process for LLM-reflection based adaptive prompt correction in multistage workflows in accordance with an illustrative embodiment.

### DETAILED DESCRIPTION

One embodiment identifies, responsive to processing a prompt through a model, an error in an output of the model; converts the error into a score; triggers the model to convert the prompt into an argument structure (argument); causes, using the score and the argument, the model to identify a part of the argument to be replaced; generates from the model a replacement part corresponding to the part such that replacing the part with the replacement part will cause a revised prompt to result in a lower revised score; replaces, using the model to form a revised argument, the part in the argument with the replacement part; and generates, using the model, from the revised argument the revised prompt. Thus, the embodiment autonomously revises a prompt.

Another embodiment further identifies a revised error in a revised output of the model responsive to the revised prompt; determines that a revised score corresponding to the revised error is below a threshold; and produces the revised output as a final output. Thus, the embodiment autonomously improves a model's output by automatic and autonomous prompt correction.

In another embodiment, the prompt, the revised prompt, the output, and the revised output pertain to a stage in a multistage workflow, and wherein the final output is a final output of the stage and one of (i) an input of a next stage, and (ii) a final output of the multistage workflow. Thus, the embodiment autonomously improves a model's output by automatic and autonomous prompt correction in a multistage workflow.

In another embodiment, the argument comprises a set of parts, the set of parts including a background part, a goal part, a constraint part, an input part, and an output part. Thus, the embodiment provides an efficient method to part-wise modify the argument to perform prompt revisions.

Another embodiment further compares, as a part of identifying the error, the output of the model with a benchmark output provided in a supervised mode of operation of the model, the comparing resulting in the error. Thus, the embodiment autonomously improves a model's output by automatic and autonomous prompt correction in a supervised mode.

Another embodiment further compares, as a part of identifying the error in an unsupervised mode of operation of the model, the output of the model with a requirement of the prompt, the comparing resulting in the error. Thus, the embodiment autonomously improves a model's output by automatic and autonomous prompt correction in an unsupervised mode.

Another embodiment further activates a model-based agent (agent); and causes the model, by the agent, to quantify the error into the score. Thus, the embodiment employs a model-based agent to evaluate the error for scoring.

Another embodiment further causes the model, by the agent to generate a reason for the score. Thus, the embodiment employs a model-based agent to evaluate the error for scoring and also provide a reasoning for the agent's score.

Another embodiment further activates a group of model-based agents (agents); configures each agent in the group with a different personality; causes each agent in the group to cause the model to quantify the error into a score corresponding to the agent; and outputs from the group a group score for the error. Thus, the embodiment employs a consensus based architecture of a group of model-based agents to evaluate the error for scoring and arrive at a consensus amongst the agents on the score.

In another embodiment, a personality of a specific agent in the group governs a manner in which the specific agent causes the model to quantify the error. Thus, the embodiment employs a consensus based architecture of a group of model-based agents to evaluate the error for scoring such that different agents score the error differently according to personalities imparted to the different agents.

Another embodiment further causes each agent in the group to cause the model to further output a corresponding reason for the score corresponding to the agent. Thus, the embodiment provides a reason for why an agent scores the error the way it did.

Another embodiment further causes a first agent in the group, the first agent having a first score and a first reason for the error, to receive for the error a second reason corresponding to a second score corresponding to a second agent in the group; and causes, by the first agent, the model to perform a re-quantification of the error using the second reason, the re-quantification outputting a revised first score corresponding to the first agent, wherein the revised first score is closer to the second score as compared to the first score. Thus, the embodiment provides a way for different agents in a group to consider another agent's reasoning and reevaluate the agent's own score in view of the other agent's reasoning.

Another embodiment further causes the second agent to receive for the error the first reason from the first agent; causes, by the second agent, the model to perform a second re-quantification of the error using the first reason, the second re-quantification outputting a revised second score corresponding to the second agent, wherein the revised second score is closer to the revised first score as compared to a separation between the first score and the second score. Thus, the embodiment provides a way for each agent in a group to consider all other agents'reasonings and reevaluate the agent's own score in view of the other agents'reasoning.

In another embodiment, the group score is a statistical average of all scores corresponding to all agents in the group. Thus, the embodiment provides one method for arriving at a unified score from a group of agents.

Another embodiment further identifies a revised error in a revised output of the model responsive to the revised prompt; determines that a revised score corresponding to the revised error is not below a threshold; and produces, for another iteration of prompt revision, a second revised prompt using the revised score. Thus, the embodiment provides an iterative process of autonomous and progressive prompt correction.

In another embodiment, the iteration of prompt revision is performed for a prompt stage in a multistage workflow. Thus, the embodiment provides an iterative process of autonomous and progressive prompt correction in a multistage workflow.

The illustrative embodiments provide a method for LLM-reflection based adaptive prompt correction in multistage workflows in a manner analogous to neural network training. The illustrative embodiments treat the entire workflow as if emulating a multi-layer neural network, and the parameter layer of each layer of the neural network is regarded as a prompt of a step. Using a network architecture like the back propagation of neural networks, gradient descent optimization mechanism, and high-way network, the illustrative embodiments use a sample of some benchmark data to automatically adjust the prompts of different steps at the same time as adjusting the neural network parameter weights until the optimal final output is achieved.

Using this method, an embodiment requires only some preliminary prompts and some sample outputs at the beginning of the multistage task, with the subsequent tasks being completed by an LLM based on the reflection mechanism. The illustrative embodiments allow the LLM to modify the prompt of each step autonomously. An embodiment also allows a human user to participate in the prompt adjustment when necessary.

The illustrative embodiments follow certain steps which are summarized as follows—
1. Error measurement mechanism based on reflection (this step is analogous to the concept of “loss” in traditional neural networks.)
2. Token-based prompt argument division (the prompt arguments can be regarded as being analogous to parameters of traditional neural networks.)
3. Error-based prompt argument adjustment (prompt argument adjustment can be regarded as being analogous to parameter adjustment in traditional neural networks.)

In the error measurement process according to an embodiment, the embodiment establishes an error measurement mechanism based on reflection, in a manner analogous to the traditional neural network loss. The objective of the error measurement process is to find the error between the actual output value and an ideal or benchmark output value. the embodiment uses this error in forming a quantitative indicator of the error, and then performing a backward transmission based on the quantitative indicator.

In one embodiment, the error measurement mechanism can be implemented as a supervised operation. The supervised error measurement mechanism, according to the embodiment, is supplied with “correct answers” (also referred to interchangeably as the benchmark or ideal output value(s)) as a reference standard. The embodiment measures the error between the actual output/answer and the correct output/answer.

In another embodiment, the error measurement is implemented as an unsupervised operation. The unsupervised measurement mechanism, according to the embodiment, does not have access to “correct answers” or ideal output values(s) as a reference standard but instead evaluates the error by the direct logical matching degree and causal relationship degree between the actual answer and the question posed in the input prompt.

An embodiment sets up a scoring system for the error measurement in order to quantify the error measurement. The scoring system can be set up in two scoring modes, supervised and unsupervised, which correspond to the supervised and unsupervised error measurement mechanisms, respectively.

A score can be constructed for one or more bases of scoring, called the scoring dimensions. For each scoring dimension, an embodiment initializes a group of several LLM-agents that score these dimensions. The embodiment initializes the agent group with scoring as the theme. The embodiment configures each agent with a different initial personality and scoring angle or logic.

The agent group is setup to perform several iterations of scoring and scoring adjustments. In one embodiment, the number of iterations to be performed is configured such that the agent group collaboratively deliberates for that number of iterations, and outputting adjusted scores at each iteration.

In the first or initial iteration, each agent outputs an initial score corresponding to the error based on that agent's original LLM-based cognition configuration. Each agent also outputs a reason for the score output of that agent. In the remaining iterations, each agent reflects on the agent's own score based on the scores of other agents and makes changes. In other words, an agent reconsiders or reevaluates its own score output and reasoning in view of the score outputs and reasonings of other agents in the group. This reconsideration or reevaluation results in the agent adjusting its own score and reasoning outputs. Each agent in the group undergoes this reflection process in view of the scores and reasons outputs of other agents in the group.

Each iteration produces a group score, which is a score computed using a statistical method on the collection of scores output from the individual agents in the group in that iteration. For example, in one embodiment, the group score may be a statistical average of the individual agent scores. In another embodiment, the group score may be a weighted average of the individual agent scores based on weights associated with certain agents. From this disclosure, those of ordinary skill in the art will be able to conceive many other ways of computing a group score from the individual agent scores, and the same are contemplated within the scope of the illustrative embodiments. In any given iteration, the group score of each agent group, the score output of an agent in the group, or both, may change until the end of the iteration.

In one non-limiting example, consider an agent group of three agents, configured to score for the scoring dimension of “completeness” of the LLM output in response to a prompt. The three agents give scores of 10, 3, and 7, respectively, and their corresponding reasons in the initial iteration. Each of the three agents receives the scores and reasons given by the other one or more agents in the group, reshapes the agent's own score based on the agent's own cognition configuration (cognitive views of the LLM-based agent based on the prompt), and gives a (revised) reason for the (revised) score. After a number of iterations, the scores produced by the different agents in the group will converge-not necessarily being the same scores but the individual scores being within a tolerance limit of each other. A group score based on the converged individual agent scores is output as a final score of the error in the LLM's output corresponding to the prompt.

An embodiment uses the error score to perform prompt argument adjustment as described herein. In order to perform the prompt argument adjustment, an embodiment uses the reflection mechanism to dynamically and autonomously adjust the prompt of each step of the workflow.

The process of prompt argument adjustment begins by identifying a set of “arguments” in the prompt. This process is analogous to the backpropagation of a neural network where the smallest unit that can be changed and adjusted is the parameter in the neural network and the parameters are organized together in the form of a weight matrix. But as distinct from a neural network, in a prompt, the smallest unit that can be changed and adjusted is the token according to the concept of an “argument” as proposed by the illustrative embodiment.

According to the illustrative embodiments, an argument is a logical flow in the prompt, which logically forms a sequential relationship-that is, it follows a five-part structure called the “five-paragraph argument”. The five parts, or “paragraphs” of the “argument” as defined by the illustrative embodiments are “background,” “goal,” “constraint,” “input,” and “output.” The term “paragraph” as used herein in the context of an “argument” is not to be confused with the traditional usage of the term paragraph relative to a construct in a language. As used herein, the term “paragraph” in the context of an “argument” is a part or portion of an argument structure, and the part or portion operates to provide a specific type of information contained in the argument and may be of any suitable length or linguistic structure. A paragraph of an argument may, but need not necessarily, be identified with a marker or delimiter, a label comprising text or symbols, both the marker and the label, or neither the marker nor the label but some other manner of indicating different paragraphs of an argument that an LLM is trained to understand.

In performing the argument division on a prompt, an embodiment converts the prompt into a five-paragraph argument format by analyzing the given prompt and designating a group of one or more tokens in the prompt as one of the five paragraphs of an argument. A prompt can have any number of tokens. A token can be all or a part of a word, all or a part of a phrase, including an entire sentence. Tokens of a prompt can be organized into one or more arguments. An argument can have zero or more paragraphs of a particular type from the five types of paragraphs described above. A paragraph can have one or more tokens. Continuing with the neural network analogy, each paragraph can be regarded as a matrix in a neural network. When the prompt has to be modified, an embodiment modifies the prompt at a token-level granularity, but in units of arguments.

An embodiment then performs error-based prompt argument adjustment. Using the quantified error (from an embodiment described herein and implementable as an LLM-based error generation module), and using the token-based prompt argument division (from an embodiment described herein and implementable as an argument construction module), the embodiment adjusts one or more arguments of the prompt as follows—

The embodiment causes the LLM to determine whether the prompt in the last prompt-flow has to be changed. If the prompt has to be changed, the embodiment causes the LLM to determine which argument in the prompt should be changed. After narrowing the scope of correction to the argument level, the embodiment causes the LLM to modify the argument and generate a modified prompt. Optionally, an embodiment can also cause the LLM to indicate in the modified prompt which aspects of the original prompt (or the previous version of the prompt in case of multiple revisions) the embodiment seeks to improve.

The prompt adjustment may be executed for several iterations before proceeding to the next stage in the multistage workflow. The iterative revisions can be configured to execute until, and stop, when a prompt in the prompt-flow results in an error quantification of below a threshold quantification (termination condition). Each stage of prompting in the workflow follows this automated and autonomous LLM-based prompt revision process proposed by the illustrative embodiments. When the final revision of the final prompt in the multistage workflow meets the termination condition, the output produced by the LLM is accepted as the output for the entire workflow and the process of LLM-reflection based adaptive prompt correction in multistage workflows according to the illustrative embodiments ends.

To help address the problems with presently available prompt correction techniques and similar problems, the illustrative embodiments provide LLM-reflection based adaptive prompt correction in multistage workflows. The illustrative embodiments describe a method for automated and autonomous LLM-based prompt revision or correction process.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting on the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again, depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

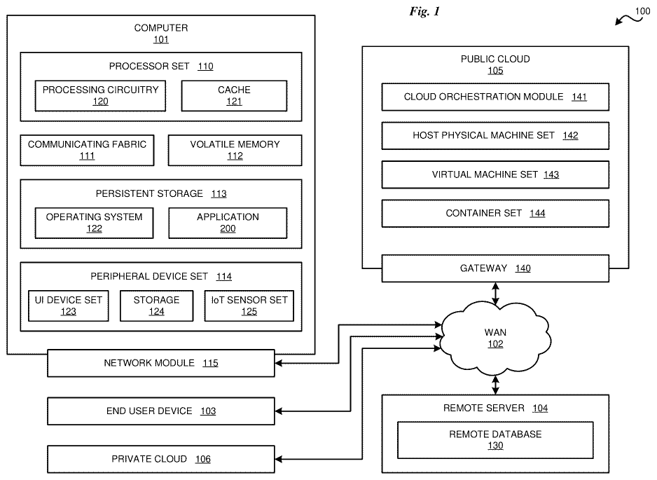

With reference to FIG. 1, this figure depicts a block diagram of a computing environment 100. Computing environment 100 contains an example of an environment for the execution of at least some of the computer code involved in performing the inventive methods, such as application 200 that may execute in computing environment 100 and implement one or more embodiments for LLM-reflection based adaptive prompt correction in multistage workflows as described herein. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

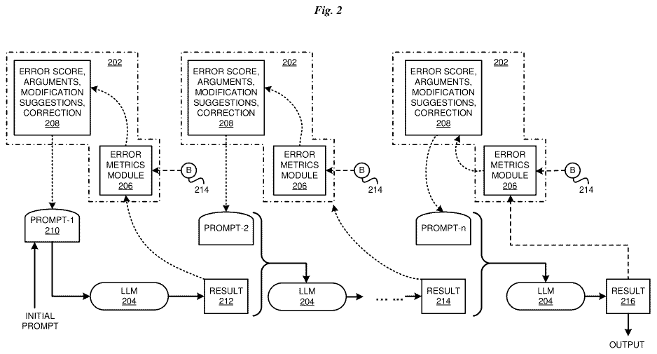

With reference to FIG. 2, this figure depicts a block diagram of a configuration for LLM-reflection based adaptive prompt correction in multistage workflows in accordance with an illustrative embodiment. Application 202 can be implemented as application 200 in FIG. 1.

Application 202 implements a portion of an embodiment described herein, and operates in conjunction with LLM 204 to provide the features described herein. Application 202 includes error metric module 206 and module 208. Error metric module 206 includes the error generation module as described herein, and implements the error quantification mechanism.

Prompt-1 210 is the first prompt in a multistage workload of prompts ranging from prompt-1 to prompt-n. A version of prompt-1 enters the system as an initial prompt, and initiates the workflow. For each version of prompt-1—including the initial and the iteratively revised versions—LLM 204 produces result 212.

In one embodiment, module 206 uses result 212 and prompt-1 to determine error in an unsupervised manner, as described herein. In another embodiment, module 206 uses result 212 and benchmark (B) 214 to determine error in a supervised manner, as described herein. Benchmark result B may or may not be available for each stage of the workflow. It is contemplated within the scope of the illustrative embodiments that any given workflow stage is operable in supervised or unsupervised mode, such that all stages may be supervised, all stages may be unsupervised, some stages may be supervised with the remaining stages being unsupervised.

Prompt-1 is iteratively revised in the first stage in a manner described herein. Specifically, module 208, operating in conjunction with LLM 204 and module 206 constructs the argument form of the latest version of prompt-1 that was used (which could be the initial prompt at the first iteration or a previous version of prompt-1 in a subsequent iteration). Module 208, operating in conjunction with LLM 204, identifies the argument(s), and selects the paragraph(s) of an argument to be modified, as described herein. Module 208, operating in conjunction with LLM 204, modifies/revises/corrects the identified argument(s) to form a revised or corrected prompt-1, as described herein.

When module 206 determines that the termination condition for the revising iterations has been met, the workflow progresses to the next stage. The next stage of the workflow uses another prompt, depicted here as prompt-2, and the latest result from the previous stage, depicted here as result 212.

A subsequent stage uses prompt-2 and result 212 as inputs to LLM 204. Module 206 uses the result produced by LLM 204 with benchmark B, if available for that stage, to determine and quantify the error in the result. Module 208 in conjunction with LLM 204 uses the error quantification to identify the arguments and paragraphs in prompt-2, revises prompt-2 to a new version, and sends to LLM for a new result in the next iteration.

The workflow iterates at the present stage, revising the latest version of the present stage prompt. The workflow progresses to the next stage when a termination condition is met for the present stage as described herein. At the last stage of the workflow (n-th stage), the result of the previous stage ((n-1)th stage) depicted here as result 214, and the prompt for the n-th stage, depicted here as prompt-n, are sent as inputs to LLM 204. Iterating through revisions of prompt-n using the latest result 216 from the n-th stage, and upon meeting the termination condition for the iterations, the configuration produces output 218, which is the final output of the configuration. Output 218 is thus produced by automatic and autonomous revision or correction of prompts in a multistage workflow according to an embodiment.

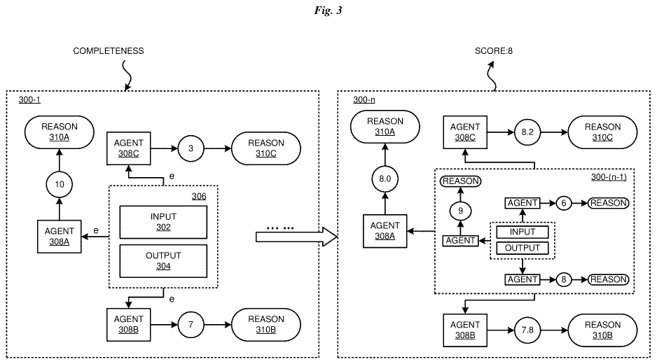

With reference to FIG. 3, this figure depicts a configuration and operation of error detection and quantification in accordance with an illustrative embodiment. Only for illustration and simplification of the description, and without implying any limitation thereto, consider configuration 300-1 operating with the first stage in FIG. 2. Accordingly, consider input 302 to be the latest prompt-1 210 used by LLM 204 and output 304 to be the latest result 212 produced from input 302. Component 306 determines the error (e) using input 302, output 304, and optionally benchmark B (Not shown) if available.

Agents 308A, 308B, and 308C are three agents, as a non-limiting example, deployed for quantification of the error (e) determined by component 306. Assume that agent 308A scores error e as 10 and provides reason 310A for that score. Similarly, agent 308B scores error e as 7 and provides reason 310B for that score; and agent 308C scores error e as 3 and provides reason 310C for that score.

In the next iteration, the three agents receive each other's scores and reasonings and reconsider their own score and reasoning. The three agents 308A-C output new scores and reasonings 310A-C, respectively, and so on, for (n-1) iterations. In the (n-1)th iteration, depicted as configuration 300-(n-1), agent 308A produces (n-1)th score 9 and a corresponding (n-1)th reason 310A, agent 308B produces (n-1)th score 8 and a corresponding (n-1)th reason 310B, and agent 308C produces (n-1)th score 6 and a corresponding (n-1)th reason 310C.

The n-th iteration of this agent group deliberation is depicted in configuration 300-n. In the n-th iteration, consensus is reached between agents 308A-C, each producing a scores of 8.0, 7.8, and 8.2, respectively, which are deemed to be within a tolerance of each other (assuming an example tolerance of 0.5). With a group score of 8, the error e is quantified and presented to module 208 of FIG. 2, which uses the score for further operations, as described herein. Eventually, through revisions of the prompt, the overall error in the output reduces such that the group score by agent consensus falls below a threshold score. When the group score falls below a threshold score, the stage output is deemed to be correct and final for the stage, further iterations for prompt revision are terminated for the stage, and the workflow proceeds with the output to the next stage.

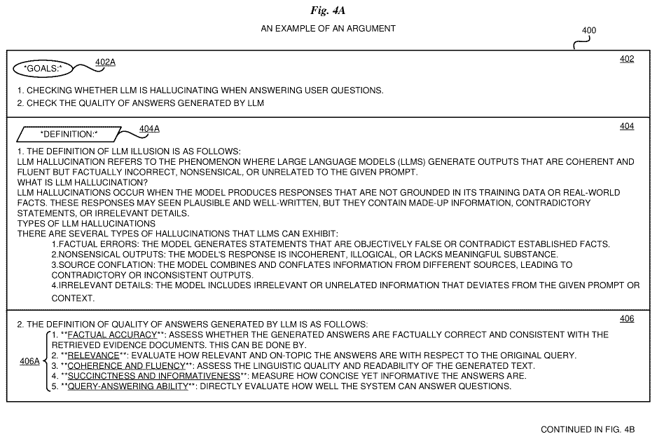

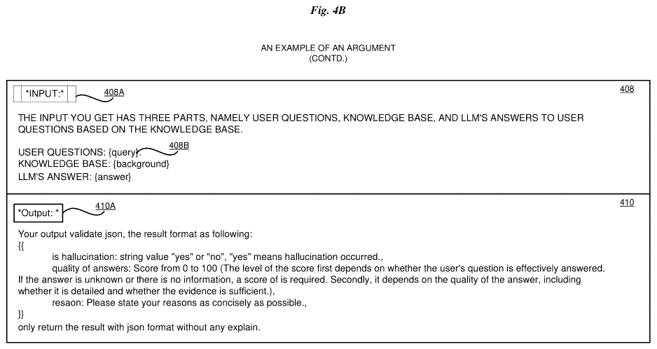

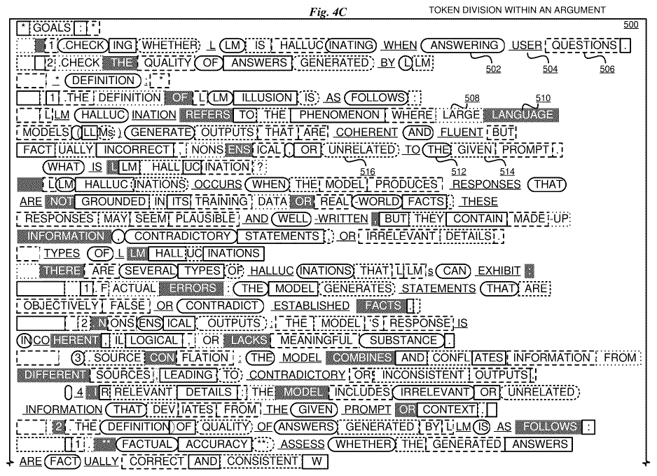

With reference to FIG. 4A, this figure depicts one portion of a five-paragraph argument form of a prompt to be tokenized for argument adjustment in accordance with an illustrative embodiment. FIG. 4A depicts the first portion of argument 400.

With reference to FIG. 4B, this figure depicts another portion of the five-paragraph argument form of a prompt to be tokenized for argument adjustment in accordance with an illustrative embodiment. FIGS. 4A-4B collectively form the five-paragraph argument, with FIG. 4B depicting the second portion of argument 400.

With reference to FIG. 4C, this figure depicts an example portion of the tokenized five-paragraph argument form of the prompt in accordance with an illustrative embodiment.

In FIG. 4A, argument 400 shows paragraphs 402, 404, and 406. Label 402A identifies paragraph 402 as the “goal” type of paragraph in the five-paragraph structure of argument 400. Label 404A identifies paragraph 404 as the “definition”—a type “background” type of paragraph in the five-paragraph structure of argument 400. A plurality of labels 406A form paragraph 406, which is the “constraint” type of paragraph in the five-paragraph structure of argument 400.

Continuing in FIG. 4B, argument 400 shows paragraphs 408 and 410. Label 408A identifies paragraph 408 as the “input” type of paragraph in the five-paragraph structure of argument 400. Label 410A identifies paragraph 410 as the “output” type of paragraph in the five-paragraph structure of argument 400. In paragraph 408, the actual user query or input prompt could be represented in the non-limiting example manner of query 408B, as shown. Single and double asterisks are optionally used in some cases as paragraph markers in argument 400 as non-limiting examples.

Tokenized form 500 of argument 400 is depicted in FIG. 4C. The various tokens identified in argument 400, and paragraphs thereof, are shaded differently only for visual representation in drawings, e.g., tokens 502, 504, 506, 508, 510, 512, 514, and 516.

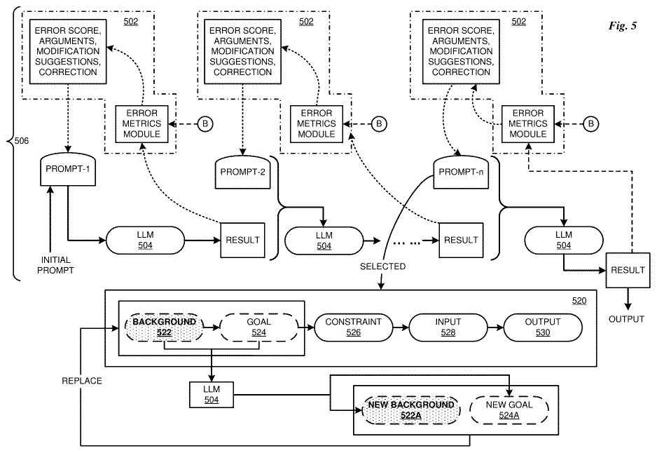

With reference to FIG. 5, this figure depicts a process of argument adjustment in accordance with an illustrative embodiment. Application 502 is an example of application 202 in FIG. 2. LLM 504 is an example of LLM 204 in FIG. 2. Operation 506 proceeds substantially as described in FIG. 2.

At any stage the prompt has to be revised or corrected. Say, for example at stage n, the latest version of prompt-n is selected for revision, as shown. Application 502, operating in conjunction with LLM 504, causes LLM 504 to organize prompt-n into five-paragraph argument 520—Background 522, goal 524, constraint 526, input 528, and output 530. application 502 causes LLM 504 to identify the paragraphs and the tokenized form thereof, that should be modified. For example, as shown in this non-limiting depiction, LLM 504 identifies “background” paragraph 522 and “goal” paragraph 524 for revision. LLM 504 outputs revised/new/replacement “background” paragraph 522A and revised/new/replacement “goal” paragraph 524A, and replaces paragraph 522 with paragraph 522A and paragraph 524 with paragraph 524A, respectively, in argument 520. Revised argument 520 is then formed into a new version of prompt-n and input into LLM for the next iteration of stage n of the workflow.

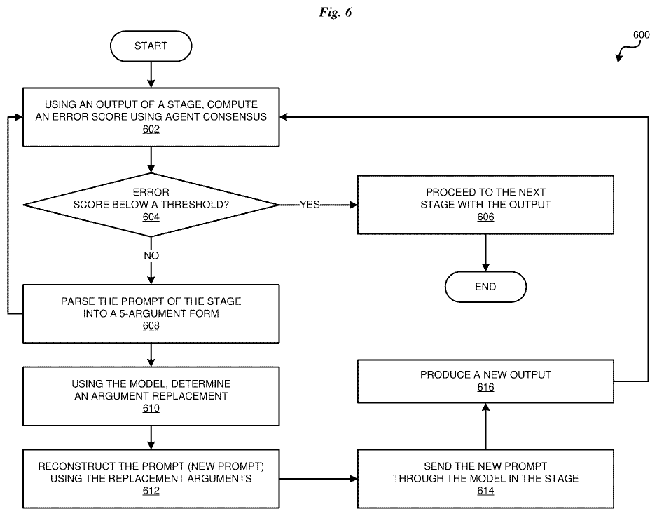

With reference to FIG. 6, this figure depicts a flowchart of an example process for LLM-reflection based adaptive prompt correction in multistage workflows in accordance with an illustrative embodiment. Process 600 can be implemented using application 502 of FIG. 5.

Process 600 begins by computing an error score using an output of a stage in an agent consensus setup (block 602). The process determines whether the group score for the error is below a threshold (block 604). If the score is below the threshold (“Yes” path of block 604), the process proceeds to the next stage with the output (block 606). The process ends thereafter and may repeat in a similar manner for another stage.

If the score is not below the threshold (“No” path of block 604), the process uses the LLM to convert the prompt into a five-argument form (block 608). The process, using the LLM, determines one or more arguments to replace (block 610). The process reconstructs a new prompt using the replacement arguments in the five-argument form (block 612). The process sends the new prompt through the LLM for the stage (block 614). The process produces a new output from the LLM in response to the new prompt (block 616). the process returns to block 602 with the new output for another iteration of automatic and autonomous prompt correction.

The following definitions and abbreviations are to be used for the interpretation of the claims and the specification. As used herein, the terms “comprises,” “comprising,” “includes,” “including,” “has,” “having,” “contains,” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (Saas) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

1. A computer-implemented method comprising:
identifying, responsive to processing a prompt through a model, an error in an output of the model;
converting the error into a score, by
constructing the score from a plurality of agent scores outputted from a corresponding plurality of agents,
the plurality of agents performing collaboratively deliberate over a number of iterations,
a first agent in the plurality of agents performing an iterative adjustment on a corresponding first agent score in the plurality of agent scores and outputting an adjusted first agent score to the plurality of agents over each iteration in the number of iterations, and
the iterative adjustment on the first agent score being based on a second agent score in the plurality of agent scores from a second agent in the plurality of agents;
triggering the model to convert the prompt into an argument structure (argument);
causing, using the score and the argument, the model to identify a part of the argument to be replaced;
generating from the model a replacement part corresponding to the part such that replacing the part with the replacement part will cause a revised prompt to result in a lower revised score;
replacing, using the model to form a revised argument, the part in the argument with the replacement part; and
generating, using the model, from the revised argument the revised prompt.

2. The computer-implemented method of claim 1, further comprising:
identifying a revised error in a revised output of the model responsive to the revised prompt;
determining that a revised score corresponding to the revised error is below a threshold; and
producing the revised output as a final output.

3. The computer-implemented method of claim 2, wherein the prompt, the revised prompt, the output, and the revised output pertain to a stage in a multistage workflow, and wherein the final output is a final output of the stage and one of (i) an input of a next stage, and (ii) a final output of the multistage workflow.

4. The computer-implemented method of claim 1, wherein the argument comprises a set of parts, the set of parts including a background part, a goal part, a constraint part, an input part, and an output part.

5. The computer-implemented method of claim 1, further comprising:
comparing, as a part of identifying the error, the output of the model with a benchmark output provided in a supervised mode of operation of the model, the comparing resulting in the error.

6. The computer-implemented method of claim 1, further comprising:
comparing, as a part of identifying the error in an unsupervised mode of operation of the model, the output of the model with a requirement of the prompt, the comparing resulting in the error.

7. The computer-implemented method of claim 1, further comprising:
activating a model-based agent (agent) in the plurality of agents; and
causing the model, by the agent, to quantify the error into the score.

8. The computer-implemented method of claim 7, further comprising:
causing the model, by the agent to generate a reason for the score.

9. The computer-implemented method of claim 1, further comprising:
activating, as the plurality of agents, a group of model-based agents (agents);
configuring each agent in the group with a different personality;
causing each agent in the group to cause the model to quantify the error into an agent score corresponding to the agent; and
outputting from the group a group score for the error.

10. The computer-implemented method of claim 9, wherein a personality of a specific agent in the group governs a manner in which the specific agent causes the model to quantify the error.

11. The computer-implemented method of claim 9, further comprising:
causing each agent in the group to cause the model to further output a corresponding reason for the agent score corresponding to the agent.

12. The computer-implemented method of claim 11, further comprising:
causing the first agent in the group, the first agent having the first agent score and a first reason for the error, to receive for the error a second reason corresponding to the second agent score corresponding to the second agent in the group; and
causing, by the first agent, the model to perform a re-quantification of the error using the second reason, the re-quantification outputting a revised first agent score corresponding to the first agent, wherein the revised first agent score is closer to the second agent score as compared to the first agent score.

13. The computer-implemented method of claim 12, further comprising:
causing the second agent to receive for the error the first reason from the first agent; and
causing, by the second agent, the model to perform a second re-quantification of the error using the first reason, the second re-quantification outputting a revised second agent score corresponding to the second agent, wherein the revised second agent score is closer to the revised first agent score as compared to a separation between the first agent score and the second agent score.

14. The computer-implemented method of claim 9, wherein the group score is a statistical average of all agent scores corresponding to all agents in the group.

15. The computer-implemented method of claim 1, further comprising:
identifying a revised error in a revised output of the model responsive to the revised prompt;
determining that a revised score corresponding to the revised error is not below a threshold; and
producing, for another iteration of prompt revision, a second revised prompt using the revised score.

16. The computer-implemented method of claim 15, wherein the iteration of prompt revision is performed for a prompt stage in a multistage workflow.

17. A computer program product comprising:
One or more computer readable storage media; and
program instructions stored on the one or more storage media and configured to perform operations comprising:
identifying, responsive to processing a prompt through a model, an error in an output of the model;
converting the error into a score, by
constructing the score from a plurality of agent scores outputted from a corresponding plurality of agents,
the plurality of agents performing collaboratively deliberate over a number of iterations,
a first agent in the plurality of agents performing an iterative adjustment on a corresponding first agent score in the plurality of agent scores and outputting an adjusted first agent score to the plurality of agents over each iteration in the number of iterations, and
the iterative adjustment on the first agent score being based on a second agent score in the plurality of agent scores from a second agent in the plurality of agents;
triggering the model to convert the prompt into an argument structure (argument);
causing, using the score and the argument, the model to identify a part of the argument to be replaced;
generating from the model a replacement part corresponding to the part such that replacing the part with the replacement part will cause a revised prompt to result in a lower revised score;
replacing, using the model to form a revised argument, the part in the argument with the replacement part; and
generating, using the model, from the revised argument the revised prompt.

18. The computer program product of claim 17, wherein the stored program instructions are stored in a computer readable storage device in a data processing system, and wherein the stored program instructions are transferred over a network from a remote data processing system.

19. The computer program product of claim 17, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

20. A computer system comprising a processor and one or more computer readable storage media, and program instructions collectively stored on the one or more computer readable storage media, the program instructions executable by the processor to cause the processor to perform operations comprising:
identifying, responsive to processing a prompt through a model, an error in an output of the model;
converting the error into a score, by
constructing the score from a plurality of agent scores outputted from a corresponding plurality of agents,
the plurality of agents performing collaboratively deliberate over a number of iterations,
a first agent in the plurality of agents performing an iterative adjustment on a corresponding first agent score in the plurality of agent scores and outputting an adjusted first agent score to the plurality of agents over each iteration in the number of iterations, and
the iterative adjustment on the first agent score being based on a second agent score in the plurality of agent scores from a second agent in the plurality of agents;
triggering the model to convert the prompt into an argument structure (argument);
causing, using the score and the argument, the model to identify a part of the argument to be replaced;
generating from the model a replacement part corresponding to the part such that replacing the part with the replacement part will cause a revised prompt to result in a lower revised score;
replacing, using the model to form a revised argument, the part in the argument with the replacement part; and
generating, using the model, from the revised argument the revised prompt.
